(19) United States
(12) Patent Application Publication
(10) Pub. No.: US 2025/0252503 A1
(43) Pub. Date: Aug. 7, 2025

(54) ELECTRONICALLY BLOCKING CREATION OF NEW INSURANCE POLICIES AT AN ELECTRONIC INSURANCE MANAGEMENT SYSTEM

(71) Applicant: Allstate Insurance Company, Northbrook, IL (US)

(72) Inventors: Bonnie S. Gill, Hoffman Estates, IL (US); David M. Samuels, Glenview, IL (US)

(21) Appl. No.: 19/046,054

(22) Filed: Feb. 5, 2025

Related U.S. Application Data
(63) Continuation of application No. 14/625,116, filed on Feb. 18, 2015, now abandoned.

(51) Int. Cl. G06Q 40/08; G06Q 10/0635

(52) U.S. Cl. CPC G06Q 40/08; G06Q 10/0635

(57) ABSTRACT

Systems and methods are provided for evaluating aggregate risk exposure of insurance policies associated with a geographical area. An insurance system may include an aggregate risk management system, which calculates an aggregate risk exposure of insurance policies associated with a geographical area, and compares the aggregate risk exposure with a maximum tolerable risk exposure for the geographical area. Based on the comparison, the aggregate risk management system determines whether more insurance policies may be issued associated with the geographical area. The aggregate risk management system may issue a block at an insurance system to prevent new insurance policies associated with a geographical area based on the aggregate risk exposure for that geographical area.

### CROSS-REFERENCE TO RELATED APPLICATIONS

The present application is a continuation of and claims priority to U.S. patent application Ser. No. 14/625,116 filed on Feb. 18, 2015, which is incorporated by reference in its entirety herein.

### BACKGROUND

Insurance companies may provide different types of insurance policies in different geographical areas. When an insurance company receives a request for a new insurance policy, it may choose to evaluate the potential risk of issuing that policy. After determining that a requested insurance policy has an acceptable risk exposure, an insurance company may choose to issue that policy. However, some current techniques evaluate the risk of a new insurance policy in isolation, without reference to the insurance company's existing portfolio of insurance policies. Evaluating the potential risk of an insurance policy in isolation might cause the insurance company to have an imbalance portfolio with concentrated areas of high risk.

Some insurance companies might prefer to issue insurance policies across various geographical areas, such that their risk exposure is spread across several perils. If however, an insurance company could determine aggregate risk exposure of current and requested insurance policies at specific geographical areas, that insurance company may be able to manage and maintain a balance portfolio. Moreover, an insurance company may be able to leverage that aggregate risk exposure to make business recommendations, such as whether to continue issuing insurance policies at a micro-geographic level without exceeding the business' maximum tolerable risk level. Accordingly there exists a need for such techniques.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

A first aspect described herein provides an aggregate risk management system. The aggregate risk management system may include one or more processors, an insurance policy database that stores information describing an insurance policy and information identifying a geographical area associated with the insurance policy, and a capacity information database that stores a maximum tolerable risk exposure value applicable to the geographic area. The one or more processors of the aggregate risk management system may be programmed to, in operation, obtain an aggregate risk exposure value that indicates a risk exposure for the geographical area based, at least partially, on the insurance policy associated with the geographical area. The one or more processors of the aggregate risk management system may be further programmed to perform a comparison of the aggregate risk exposure value to the maximum tolerable risk exposure value and prevent, at an insurance system, the issuance of new insurance policies associated with the geographical area based on this comparison. The one or more processors of the aggregate risk management system are programmed to prevent issuance of new insurance policies associated with a geographical area by issuing a block on the geographical area at the insurance system.

A second aspect described herein provides that the one or more processors of the aggregate risk management system may be programmed to, in operation, receive a request to issue an insurance policy associated with a geographical area. The one or more processors of the aggregate risk management system may be programmed to obtain an aggregate risk exposure based on the new insurance policy request and the insurance policy associated with the geographical area. Further, the one or more processors of the aggregate management system may be programmed to prevent, at an insurance system, issuance of new insurance policies associated with the geographical area by rejecting the insurance policy request.

The details of these and other aspects of the disclosure are set forth in the accompanying drawings and description below. Other features and advantages of aspects of the disclosure will be apparent from the description and drawings.

### BRIEF DESCRIPTION OF THE DRAWINGS

Aspects of the disclosure may be implemented in certain parts, steps, and embodiments that will be described in detail in the following description and illustrated in the accompanying drawings in which like reference numerals indicate similar elements. It will be appreciated with the benefit of this disclosure that the steps illustrated in the accompanying figures may be performed in other than the recited order and that one or more of the steps may be optional. It will also be appreciated with the benefit of this disclosure that one or more components illustrated in the accompanying figures may be positioned in other than the disclosed arrangement and that one or more of the components illustrated may be optional.

FIG. 1 is a block diagram of an example computing system.

FIG. 2 is a block diagram of an example of an implementation of an insurance system including an aggregate risk management system.

FIG. 3 is a flowchart of high-level example method steps of an aggregate risk management system.

FIG. 4 is a flowchart of example method steps for calculating aggregate risk exposure at a specific geographical area.

FIG. 5 is a flowchart of example method steps for evaluating the aggregate risk exposure at a specific geographical area.

FIG. 6 is a flowchart of example method steps for taking actions based on the evaluation.

FIG. 7 is a diagram of an example summary report published by an insurance system.

FIG. 8 is a flowchart of example method steps of an aggregate risk management system.

### DETAILED DESCRIPTION

Aspects of the present disclosure are directed toward an aggregate risk management system for insurance policies. At regular intervals or on-demand, the aggregate risk management system evaluates an insurance company's current insurance policies (i.e. not expired) at each geographical area. As part of this evaluation, the system determines whether the insurance company's aggregate risk exposure in that geographical area is below the insurance company's risk tolerance for that geographical area. If the insurance company's aggregate risk exposure is at or above the risk tolerance, the system ensures that the insurance company's agents are not able issue new policies in that geographical area. Alternatively, if the insurance company's risk is below the risk tolerance, the system may direct the insurance company's agents to obtain more or less of a certain type of insurance, based on this evaluation and general business goals.

As used in this description, an insurance agent (“agent”) refers to an individual employed by an insurance company to obtain and issue insurance policies for insurance customers. As used in this description, an insurance customer (“customer”) refers to an individual that has purchased an insurance policy from an insurance company which insures the customer against loss. As used in this description, loss refers to, e.g., a loss of life of an insured individual, bodily injury of an insured individual, damage to a vehicle, damage to personal property, damage to real property, and other types of injuries and damage that will be recognized by those familiar with insurance services.

It is also to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof, as well as additional items and equivalents thereof. Moreover, aspects of the disclosure may be implemented in non-transitory computer-readable media having instructions stored thereon that, when executed by a processor, cause the processor to perform various steps described in further detail below. As used in this description, non-transitory computer-readable media refers to all computer-readable media with the sole exception being a transitory propagating signal.

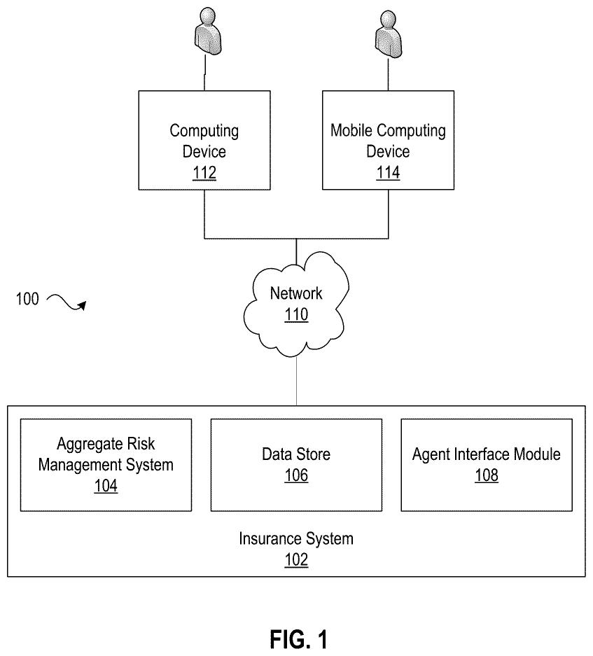

FIG. 1 is an illustration of an example implementation of a computing system 100. The computing system 100 may include an insurance system 102. The insurance system 102 may include an agent interface module 108 that insurance agents (“agents”) may access to issue new insurance policies, update existing insurance policies, process insurance claims, and perform other insurance-related tasks. Agents may access the insurance system 102 using a computing device 112. Agents may also access the insurance system 102 using a mobile computing device 116. The computing device 112 and mobile computing devices 114 may be in signal communication with the insurance system 102 via a network 110. The network may include one or more of a wired network (e.g., the Internet), a wireless network (e.g., a cellular network), or a combination of wired and wireless networks. A computing device 112 may be, for example, a desktop computer, laptop computer, tablet computer, palmtop computer, or other type of computing device configured for network communications. Agents may thus access the insurance system 102 using, e.g., a web browser, desktop application, or the like that resides at the computing device 104. A mobile computing device 114 may be, for example, a smartphone. Agents may thus access the insurance system 102 using, e.g., a mobile application or the like that resides at the mobile computing device 114.

The insurance system 102 may also include an aggregate risk management system 104. The aggregate risk management system 104 may be configured to, in operation, evaluate current policies for aggregate risk exposure, and communicate its determinations to the agents through the agent interface module 108. Additionally or alternatively, the insurance system 102 may include a data store 106 that maintains information related to policies, agents, claims, and other insurance-related data. The aggregate risk management system 104 may gather data from the data store 106 in order to make its determinations of risk exposure.

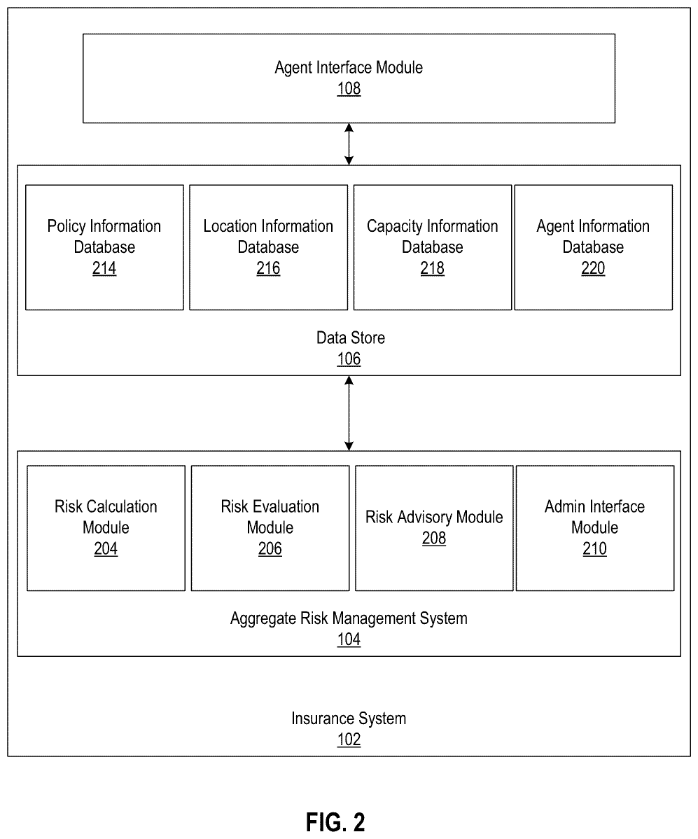

In FIG. 2, the example of an insurance system 102 of FIG. 1 is shown in further detail. The insurance system 102 may include various components, modules, and sub-systems that facilitate various insurance-related tasks, including evaluating the insurance company's current policies for risk exposure. It will be appreciated that the insurance system 102 illustrated in FIG. 2 is shown by way of example and that other implementations of insurance systems 102 may include additional or alternative components, modules, sub-systems, and so forth.

The insurance system 102, in this example, includes an aggregate risk management system 104, a data store 106, and an agent interface module 108.

The data store 106 may store information related to insurance policies and insurance claims, as well as information utilized for risk management. The data store 106 may comprise one or more databases to store information associated with insurance policies, geographical areas, maximum tolerable risk exposures, and agents. The data store 106 may thus include a policy information database 214, a location information database 216, a capacity information database 218, and an agent information database 220. The aggregate risk management system 104 may utilize and update this information in evaluating the insurance company's risk exposure in a geographical area and make determinations for the insurance agents based on these evaluations. The data store 106 may alternatively be implemented as a combination of the policy information database 214, a location information database 216, a capacity information database 218, and an agent information database 220.

For example, the policy information database 214 may store information associated with current insurance policies, e.g., policy numbers, terms, effective dates, deductibles, addresses, insured value, probable maximum loss (PML), and other insurance-related information that will be appreciated by those familiar with insurance systems and services. The various modules of the insurance system 102 may update the policy information database 214 when an insurance agent issues a new insurance policy or updates an existing insurance policy through the agent interface module 108.

The location information database 216 may store information associated with geographical areas for which there exist current insurance policies. Geographical areas may vary in level of granularity. In some examples, geographical areas may be defined by geocodes (e.g. latitude/longitude), buildings, street addresses, municipal blocks, zip codes, districts, counties, cities, states, and countries. Additionally, the location information database 216 may maintain, e.g., through a database relationship, an association between a geographical area and one or more insurance policies in the policy information database 214. For example, an insurance policy may be considered to be associated with a geographical area when an insurance policy holder listed on the insurance policy resides within the geographical area. In another example, an insurance policy may be considered to be associated with a geographical area when property or real property that is insured by the insurance policy is stored or otherwise located in the geographical area. It will be appreciated by those skilled in the art that other circumstances may also result in an association between an insurance policy and a geographical area.

The various modules of the insurance system 102 may update the location information database 216 when an insurance agent issues a new insurance policy or updates an existing insurance policy through the agent interface module 108. For example, for a new or updated insurance policy, the insurance system 102 may determine the geographical areas which will be associated with the insurance policy. The insurance system 102 may then update the location information database 216 to include the geographical areas associated with the new or updated insurance policy. In some embodiments, the insurance system 102 may only add the geographical areas not already present in the location information database 216.

The capacity information database 218 may store information that describes maximum tolerable risk exposure for a geographical area, where maximum tolerable risk exposure represents the maximum amount of risk an insurance company is willing to tolerate in a particular geographic area. The capacity information may thus include a maximum tolerable risk exposure for each geographical area in the location information database 216. The capacity information database 218 may also maintain, e.g., through a database relationship, an association between a maximum tolerable risk exposure and a geographical area in the location information database 216. In some examples, the maximum tolerable risk exposure may be expressed as a monetary value, a rating (e.g., a set or range of values), or a category (e.g., Low Risk, Medium Risk, High Risk, Critical Risk). Additionally or alternatively, the capacity information database 218 may provide a baseline maximum tolerable risk exposure to apply to all geographical areas, where the baseline maximum tolerable risk exposure represents a default maximum tolerable risk exposure. The insurance system 102 may use the baseline maximum tolerable exposure where a maximum tolerable risk exposure for a geographical area is undefined.

The various modules of the insurance system 102 may update the capacity information database 218 when a system administrator creates or updates capacity information for a geographical area. Additionally or alternatively, the insurance system 102 may update the capacity information database 218 when an insurance agent issues a new insurance policy or updates an existing insurance policy through the agent interface module 108. For example, for a new or updated insurance policy, the insurance system 102 may determine the geographical areas associated with the insurance policy, and update the capacity information database 218 to include a maximum tolerable risk exposure for the geographical areas. In some embodiments, the insurance system 102 may only add or update maximum tolerable risk exposures for geographical areas without a maximum tolerable risk exposure already defined in the capacity information database 218. Further, in some examples, the insurance system 102 may update the capacity information database 218 with baseline tolerable risk exposures for the geographical areas associated with the new or updated policy. The aggregate risk management system 104 may also receive from the agent interface module 108 requests to issue new insurance policies and either accept or reject the new insurance policy requests based on the tolerable risk exposure for a geographic area as described in further detail below.

In some example implementations, following an update to the location information database 216 (e.g., the addition of a new geographical area following a new or updated insurance policy) or an update to the capacity information database 218 (e.g., the addition of a new maximum tolerable risk exposure following a new or updated insurance policy), the aggregate risk management system 104 may automatically trigger a risk evaluation. In other embodiments, the aggregate risk management system 104 may automatically trigger a risk evaluation for only the geographical areas receiving updated maximum tolerable risk exposures. This alternate embodiment may advantageously provide an efficient use of system resources.

The agent information database 220 may store information associated with agents of the insurance company. The agent information may include an agent's name, contact information, and system preferences.

The aggregate risk management system 104 may include various components for managing risk exposure at a geographical area. The aggregate risk management system 104, in this example, includes a risk calculation module 204, a risk evaluation module 206, a risk advisory module 208, and an admin interface module 210. Example implementations of these modules will be described in further detail below. Further, as noted above, these modules are described by way of example only and other implementations of an aggregate risk management system 104 may include additional or alternative modules.

The admin interface module 210 in FIG. 2 may be configured to, in operation, allow aggregate risk management system administrators (“administrators”) to control the operation of the aggregate risk management system 104. The admin interface module 210 may include one or more user interfaces, through which administrators may manage aggregate risk management system. For example, the admin interface module 210 may include a user interface to set or update a maximum tolerable risk exposure for a geographical area in the capacity information database 218, such that a baseline maximum tolerable risk exposure or a maximum tolerable risk exposure at a geographical area can be substituted with a new maximum tolerable risk exposure for the geographical area. The admin interface module 210 may also include a user interface to define a new baseline maximum tolerable exposure for all geographical areas.

In other examples, the admin interface module 210 may include a user interface to change the frequency (e.g. daily, weekly, monthly, quarterly, yearly) at which the aggregate risk management system 104 performs its evaluation. In other examples, the admin interface module 210 may also include a user interface to trigger an on-demand risk evaluation by the aggregate risk management system 104. Additionally or alternatively, this user interface may include the ability to trigger an on-demand risk evaluation for one or more specified geographical areas by the aggregate risk management system 104. In some example implementations, following an update to the capacity information database 218 through the admin interface module 210, the aggregate risk management system 104 may automatically trigger a risk evaluation. In other embodiments, the aggregate risk management system 104 may automatically trigger a risk evaluation for only the geographical areas receiving updated maximum tolerable risk exposures. This alternate embodiment may advantageously provide an efficient use of system resources.

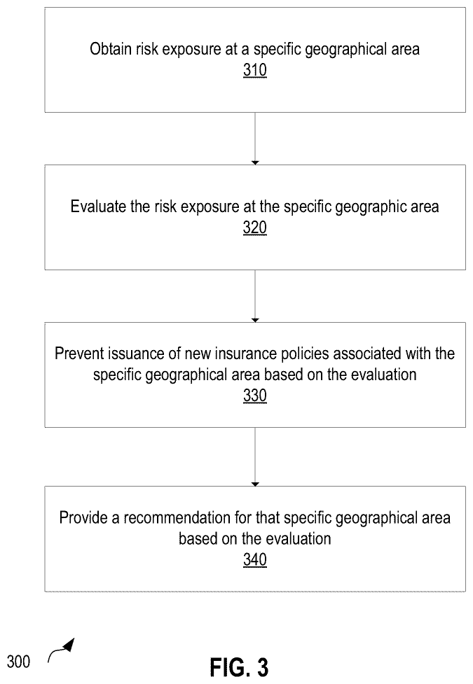

Referring now to FIG. 3, a flowchart 300 of high-level example method steps of an aggregate risk management system 104 is shown. The various components of the aggregate risk management system 104 may be used to perform these method steps for a geographical area in the location information database 214. The risk calculation module 204 may be configured to, in operation, obtain an aggregate risk exposure at a geographical area (block 310). The risk evaluation module 206 may be configured to, in operation, evaluate the aggregate risk exposure at that geographical area (block 320). The risk advisory module 208 may be configured to, in operation, prevent, at the insurance system 102, issuance of new insurance policies associated with geographical area (block 330) based on this evaluation. For example, the risk advisory module 208 may prevent, at the insurance system 102, issuance of new insurance policies by issuing a block for the geographical area. The block may prevent all new insurance policies from being issued, or it may prevent only certain types of new insurance policies from being issued. Issuing a block may include setting a flag in the location information database, the flag being associated with the geographical the block is issued for. When the flag is set, the insurance system may reject any new insurance policies insurance agents attempt to issue for that geographical area. In another example, the risk advisory module 208 may prevent, at the insurance system 102, issuance of new insurance policies by rejecting a request to issue a new insurance policy associated with that geographical area. Alternatively or additionally, the risk advisory module 208 may instruct agents not to issue new insurance policies associated with that geographical area. Additionally or alternatively, the risk advisory module 208 may be configured to, in operation, provides a recommendation for that specific geographical area based on the evaluation (block 340). For example, where the risk advisory module 208 issues a block for certain types of new insurance policies for a geographical area, the risk advisory module 208 may provide (e.g. at the agent interface module 208) a list of one or more other insurance policy types that are not blocked and can still be issued and associated with a geographical area. In this example, if new auto insurance policies are blocked for a geographical area, the risk advisory module 208 may recommend to an agent at the agent interface module 208 to issue homeowners' policies and life insurance policies associated with the geographical area instead. The aggregate risk management system 104 may repeat this process for additional geographical areas in the location information database 214.

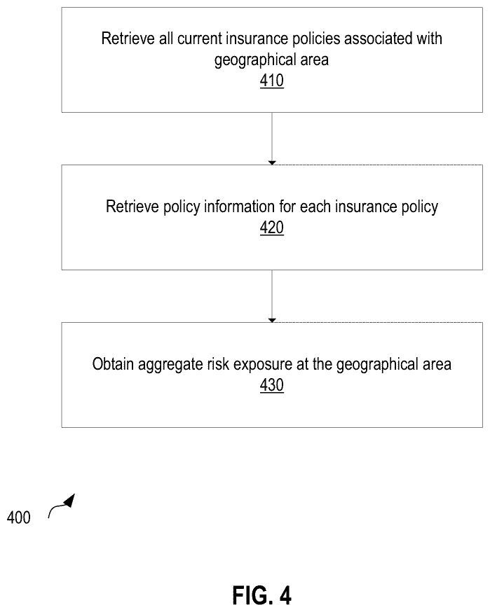

Referring now to FIG. 4, a flowchart 400 of example steps for calculating aggregate risk exposure at a specific geographical area. First, the risk calculation module 204 may retrieve current insurance policies associated with the geographical area (block 410) from the location information database 216. Where the geographical area may be represented as a set or range of geocodes (e.g. latitude and longitude), for example, the risk calculation module 204 may search the policy information database 214 for insurance policies having locations with that set or range of geocodes. For the insurance policies associated with the geographical area, the risk calculation module 204 may retrieve policy information from the policy information database 214 (block 420). In some example implementations, the risk calculation module 204 may retrieve all current insurance policies for the geographical area. In other example implementations, the risk calculation module 204 may only retrieve some of the current insurance policies for the geographical area. For example, the risk calculation module 204 may only retrieve one type of insurance policy (e.g. homeowner's insurance, auto insurance, health insurance, etc.).

Using policy information for the policies associated with the geographical area, the risk calculation module 204 may obtain an aggregate risk exposure for the geographical area (block 430). The aggregate risk exposure represents the risk exposure for the geographical area based on one or more insurance policies associated with the geographical area, and may be based on one or more location and policy attributes. In at least one embodiment, an insurance company may calculate the aggregate risk exposure. For example, the aggregate risk exposure may be based on a combination of the number of insurance policies associated with the geographical area, the aggregate insured value of insurance policies associated with the geographical area, and the aggregate probable maximum loss (PML) of insurance policies associated with the geographical area. The aggregate insured value represents a mathematical combination (e.g., an average, a sum, a maximum) of individual insured values of one or more respective insurance policies associated with a geographical area. Similarly, the aggregate probable maximum loss (PML) represents a mathematical combination (e.g., an average, a sum, a maximum) of individual PMLs of one or more respective insurance policies associated with a geographical area or, additionally or alternatively, an output from a mathematical exercise in estimating insured loss for one or more respective insurance policies associated with a geographical area. It will be appreciated with the benefit of this disclosure that the aggregate risk exposure may also be based on other insurance-related attributes, criteria, or information. In combining one or more location and policy attributes to obtain the aggregate risk exposure, the risk calculation module 204 may give each attribute an equal weight or different weights to each of the attributes. The risk calculation module 204 may express the aggregate risk exposure as a monetary value, a rating (e.g., a set or range of values), or a category (e.g., Low Risk, Medium Risk, High Risk, Critical Risk).

In other examples, a risk calculation module 204 may obtain an aggregate probable maximum loss (PML), aggregate insured value, or aggregate risk exposure for a geographical area from a third-party remote system. In this example, the risk calculation module 204 may provide the third-party remote system with policy information for the policies associated with the geographical area, and may indicate whether to calculate an aggregate PML, aggregate insured value, or aggregate risk exposure for a geographical area. Accordingly, the risk calculation module 204 may expect an aggregate PML, aggregate insured value, or aggregate risk exposure in response. It will be appreciated that the insurance system 102 will perform de-identification on all customer and policy information before providing this information to a third-party remote system. The information provided to a third-party remote system will thus be anonymous to protect the privacy of the insurance company's customers. Any information that could be used to determine the identity of the insurance company's customers is withheld from the third-party remote system. Additionally, the information provided to the third-party remote system may be limited to the information necessary to calculate the aggregate PML, aggregate insured value, or aggregate risk exposure.

In some example implementations, where the risk calculation module 204 may retrieve all current insurance policies for a geographical area, the aggregate risk exposure (i.e. an overall aggregate risk exposure) represents the risk exposure for the geographical area based on all current insurance policies associated with the geographical area. Alternatively, where the risk calculation module 204 may retrieve only some of the current insurance policies, the aggregate risk exposure represents the risk exposure for the geographical area based only on those insurance policies. For example, where the risk calculation module 204 may retrieve only homeowner's insurance policies for a geographical area, the aggregate risk exposure (i.e. an aggregate homeowner's risk exposure) represents the risk exposure for the geographical area based only on homeowner's insurance policies. Thus, a geographical area may have multiple aggregate risk exposures depending upon the insurance policies retrieved by the risk calculation module 204. Accordingly, aggregate risk exposure for only some of the current insurance policies may be based on a combination of the number of insurance policies retrieved, the aggregate insured value of the insured policies retrieved, and the aggregate probably maximum loss (PML) of the insured policies retrieved, where the aggregate insured value and aggregate probable maximum loss (PML) may be calculated as described above.

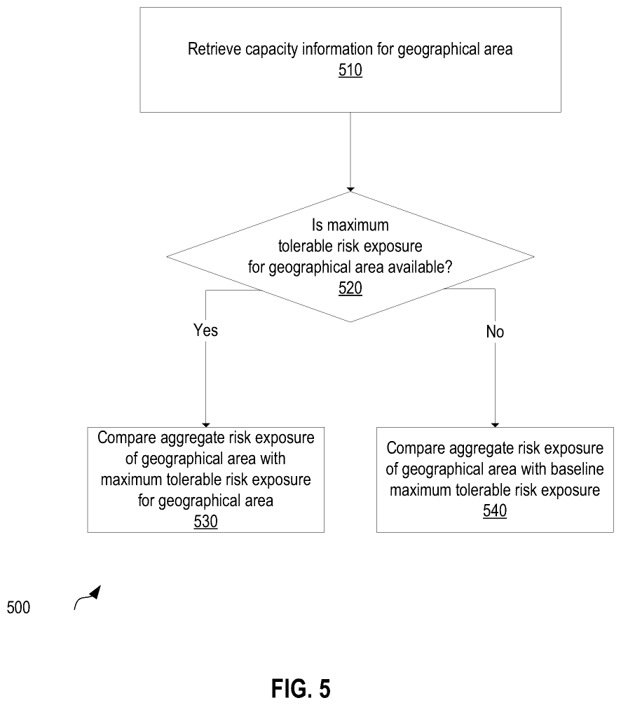

Referring now to FIG. 5, a flowchart 500 of example steps for evaluating the aggregate risk exposure at a specific geographical area. First, the risk evaluation module 206 may retrieve capacity information for the geographical area (block 510) from the capacity information database 218. The capacity information for the geographical area may include a maximum tolerable risk exposure for that geographical area, and a baseline maximum tolerable risk exposure applicable to all geographical areas. The risk evaluation module 206 may determine whether the capacity information for the geographical includes a maximum tolerable risk exposure specific to that geographical area (block 520). If so, the risk evaluation module 206 may compare the aggregate risk exposure of the geographical area, as calculated by the risk calculation module 204, with the maximum tolerable risk exposure for the geographical area (block 530). If not, the risk evaluation module 206 may compare the aggregate risk exposure of the geographical area with the baseline maximum tolerable risk exposure (block 540).

As noted above, the aggregate risk exposure and the maximum tolerable risk exposure may be, in some examples, numerical values, where the risk evaluation module 206 determines whether the aggregate risk exposure is greater than, equal to, or less than the maximum tolerable risk exposure. Also as noted above, the aggregate risk exposure and the maximum tolerable risk exposure may alternatively be risk categories (e.g. Low Risk, Medium Risk, High Risk, Critical Risk), where the risk evaluation module 206, in some examples, determines whether the aggregate risk exposure is in a higher category (e.g. Medium Risk is higher than Low Risk), the same category, or a lower category (e.g. Medium Risk is lower than High Risk) than the maximum tolerable risk exposure. Additionally or alternatively, categories may have a corresponding range of numerical values utilized to determine which risk categories are relatively higher or lower than other risk categories. For example, where a maximum tolerable risk exposure is defined as a High Risk, which may correspond to a range of 101-200, and the aggregate risk exposure is calculated as a numerical value, the risk evaluation module 206 determines whether aggregate risk exposure falls within, below, or above the 101-200 range.

In some examples, where the aggregate risk exposure is less than the maximum tolerable risk exposure, the risk evaluation module may also determine the discrepancy between the aggregate risk exposure and the maximum tolerable risk exposure. The discrepancy may be expressed in terms of an absolute value, fraction, or percentage.

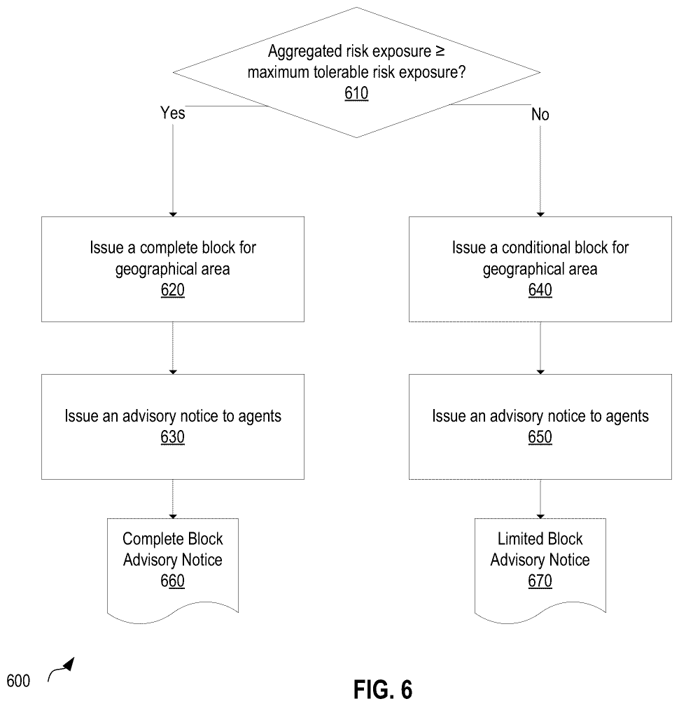

Referring now to FIG. 6, a flowchart 600 of example steps for taking actions based on the evaluation is shown. The risk advisory module 208 may receive an evaluation for a geographical area from the risk evaluation module 206, and may decide to prevent, at the insurance system 102, issuance of all or certain types of new insurance policies associated with the geographical area based on the evaluations. The risk advisory module may prevent, at the insurance system 102, issuance of insurance policies by issuing a complete block, a limited block, or an advisory notice as described by way of example above. The risk advisory module 208 may first determine, from the evaluation, whether the aggregate risk exposure was greater than or equal to the maximum tolerable risk exposure (block 610). If so, the risk advisory module 208 may issue a complete block for the geographical area (block 620). Preventing the issuing of all new insurance policies associated with the geographical area may be referred to as a complete block. For example, the complete block may ensure that agents accessing the insurance system 102 through the agent interface module 108 from a computing device 202 are not able to issue any new insurance policies associated with that geographical area. An insurance policy may be considered to be associated with a geographical area when an insurance policy holder listed on the insurance policy resides within the geographical area. In other example, an insurance policy may be considered to be associated with a geographical when property or real property that is insured by the insurance policy is stored or otherwise located in the geographical area. It will be appreciated by those skilled in the art that other circumstances may also result in an association between an insurance policy and a geographical area.

Further, the complete block may ensure that agents are not able to update existing insurance policies to be associated with that geographical area. Additionally or alternatively, the complete block may also ensure that agents are not able to adjust terms of existing insurance policies upon renewal period of that insurance policy. Other examples with respect to issuing, updating, modifying, and renewing insurance policies will be appreciated by those skilled in the art.

Additionally or alternatively, the risk advisory module 208 may issue complete block advisory notices 660 (e.g. email, SMS, MMS, push notification, instant messaging, telephone call, fax) to agents (block 630). The insurance system 202 may allow agents to select, through the agent interface module 108, preferred methods of receiving complete block advisory notices 660. The agent's preferences and contact information are stored in the agent information database 220. The complete block advisory notice 660 communicates to agents that the geographical area has been blocked, such that the insurance system 202 will prevent the agents from issuing new insurance policies, updating existing insurance policies to be associated with the geographical area, and so forth.

In some examples, the risk advisory module 208 may update the location information database 216 to reflect that a geographical area is completely blocked, e.g., by setting a flag stored for a geographical area described by information stored in the location information database 216.

Alternatively, if the aggregate risk exposure was less than the maximum tolerable risk exposure, the risk advisory module 208 may issue a limited block for the geographical area (block 640). Preventing the issuing of certain types of insurance policies associated with the geographical area may be referred to as a limited block. For example, the limited block may ensure that agents accessing the insurance system 102 through the agent interface module 108 from a computing device 202 are not able to issue certain types of insurance policies (e.g. health insurance, life insurance, homeowner's insurance, renter's insurance, auto insurance). The risk advisory module 208 evaluates the discrepancy between the aggregate risk exposure and the maximum tolerable risk exposure, as calculated by the risk evaluation module 206, to determine which types of insurance policies may still be associated with the geographical area, such that the maximum tolerable risk exposure is not met or exceeded. For example, the limited block may block agents from issuing any new homeowner's insurance policies in the geographical area, but agents may still be able to issue new health insurance policies in the geographical area.

In other examples, the risk advisory module 208 may issue a limited block, instead of complete block, for the geographical area if the aggregate risk exposure was calculated based on only a portion of the insurance policies in the geographical area (e.g. homeowner's insurance policies, auto insurance policies). For instance, where the aggregate risk exposure is an aggregate homeowner's risk exposure and is greater than the maximum tolerable risk exposure, the risk advisory module 208 may issue a limited block on issuing homeowner's insurance policies for the geographical area.

Additionally or alternatively, the risk advisory module 208 may issue limited block advisory notices 670 (e.g. email, SMS, MMS, push notification, instant messaging, telephone call, fax) to agents (block 650). The insurance system 202 may allow agents to select, through the agent interface module 108, preferred methods of receiving limited block advisory notices 670. The agents may select the same preferred methods of receiving complete block advisory notices 660 and limited block advisory notices 670. The agent's preferences and contact information are stored in the agent information database 220. The limited block advisory notice 670 communicates to agents that the geographical area has been partially blocked, such that the insurance system 202 will prevent the agents from issuing new insurance policies, or updating existing insurance policies, of certain types, to be associated with the geographical area. Further, the limited block advisory notice 670 may provide a list of the permitted types of insurance policies. The limited block advisory notice 670 may also provide a list of the blocked types of insurance policies.

In some examples, the risk advisory module 208 may update the location information database 216 to reflect that the geographical area is partially blocked, and the types of insurance policies that may still be issued in the geographical area.

Alternatively, the risk advisory module 208 may determine that neither a complete nor limited block needs to be issued for a geographical region. In this case, the risk advisory module 208 may issue a general advisory notice to agents. The general advisory notice communicates that agents may continue issuing all types of insurance policies in the geographical area.

At least according to some aspects, the insurance system 202 may allow agents to select, through the agent interface module 108, geographical areas for which they would like receive complete block advisory notices and limited block advisory notices. Accordingly, the risk advisory module 208 may only send advisory notices to agents who have elected to receive advisory notices for the geographical area.

In an example implementation, the insurance system 102 may generate and publish a summary report based on the results of the calculations and evaluations. The summary report may be generated after the risk advisory module 208 has updated the location information database 216 to reflect any complete or limited blocks. The summary report may be a combination of tabular and graphical elements. For example, the tabular elements of the summary report may list geographical areas with complete or limited blocks, and other associated information associated with the geographical area. Additionally or alternatively, the graphical elements of the summary report may depict the geographical areas on a map. The graphical elements may use one or more indicators to differentiate between geographical areas with complete blocks and limited blocks. In some examples, for geographical areas without complete or limited blocks, the tabular and graphical elements may indicate the discrepancy between the aggregate risk exposure for that geographical area and the maximum tolerable risk exposure, as calculated by the risk evaluation module 206. The insurance system 102 may publish the summary report to agents at the computing devices 202. The published summary report may also be archived in the data store 106 such that it can be viewed by agents using the agent interface module 108.

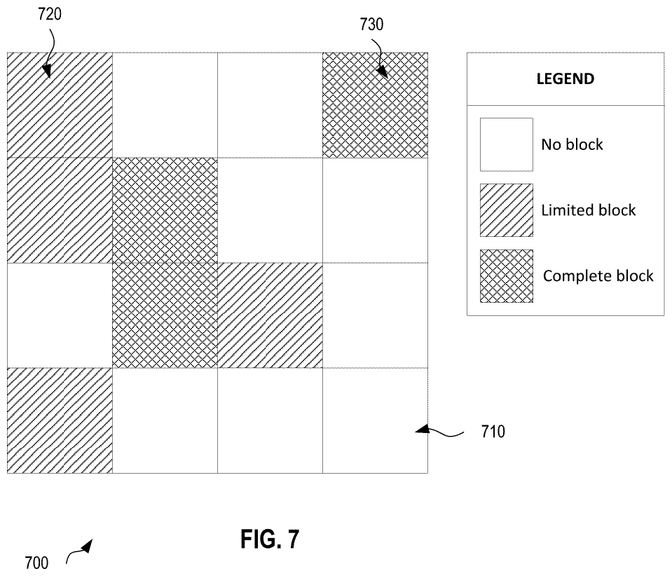

Referring now to FIG. 7, a diagram 700 of an example summary report is shown. In this example, the diagram 700 represents a map 700 of multiple contiguous geographical areas which include geographical areas 710, 720, and 730. A geographical area without no blocks may be depicted by an empty square such as that shown for geographical area 710. A geographical area with a limited block may be depicted by a partially shaded square such as that shown for geographical area 720. A geographical area with a complete block may be depicted by a fully shaded square such as that shown for geographical area 730. It will be appreciated that the diagram 700 illustrated in FIG. 7 is shown by way of example and that other implementations of a summary report may include additional or alternative components, representations, and so forth. For example, where a limited block is in force for a geographical area, the diagram may advantageously indicate which type of insurance policies are and are not blocked from issuance for that geographical area.

In an example implementation in accordance with aspects of this disclosure, the insurance company may use the results of the calculations and evaluations to adjust insurance premiums for new or updated insurance policies. For example, the insurance system 102 may trigger the risk calculation module 204 to calculate an aggregate risk exposure for a geographical area associated with the new or updated insurance policy. The insurance system 102 may subsequently trigger the risk evaluation module 206 to determine the discrepancy between the aggregate risk exposure and the maximum tolerable risk exposure for the geographical area. Based on the calculations and evaluations, the risk advisory module 208 may determine an adjusted insurance premium. For example, the risk advisory module 208 may decrease insurance premiums for new or updated insurance policies of certain types due to a limited block for a geographical area. Decreasing the insurance premiums for a certain type of insurance may encourage users to obtain more of a particular type of insurance policy. The adjusted insurance premium is communicated to the insurance system 102.

In another example implementation in accordance with aspects of this disclosure, the aggregate risk management system 104 may be used to assess whether to issue a new insurance policy. For example, an aggregate risk management system 104 may be used to calculate the aggregate risk exposure at a geographical region if an insurance policy request were issued, to evaluate whether or not to issue the new policy, and to send a notification of approval or denial of the insurance policy request based on the evaluation. In another example, the aggregate risk management system 104 may be used to calculate the aggregate risk exposure at a geographical region upon renewal of an existing insurance policy.

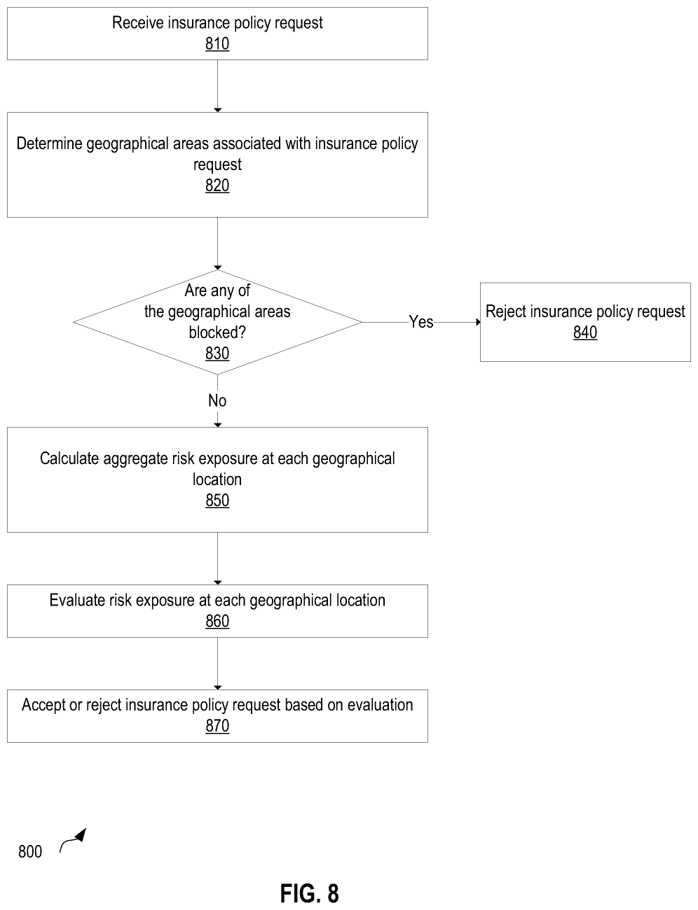

Referring now to FIG. 8, a flowchart 800 of high-level example method steps of an aggregate risk management system 104 is shown. First, the insurance system 102 may receive a request for a new insurance policy (an “insurance policy request”) at the agent interface module 108 from an agent or a customer (block 810). The insurance system 102 may then determine the geographical areas associated with the insurance policy request, based on the information provided in the request (e.g. potential policy holder's address) (block 820).

For each geographical area associated with the insurance policy request, the insurance system 102 may then synchronously (i.e., in real-time) or asynchronously trigger an evaluation by the aggregate risk management system 104. For efficiency, the aggregate management system 104 may first determine whether a geographical area is blocked (block 830), as indicated in the location information database 216. A geographical area may be considered blocked if the geographical area has a complete block, or if a limited block prevents the insurance policy request's type from being issued. If the geographical area is blocked, the remainder of the evaluation may be abandoned, including the evaluations of the other geographical areas associated with the insurance policy request, and the aggregate management system 104 may reject the insurance policy request (block 840). The rejection is communicated to the agent or the customer at the computing device 202.

If the geographical area is not blocked, the aggregate risk management system 104 may perform the calculations and evaluations as described above with reference to FIGS. 3-6 (block 850). The risk calculation module 204 may calculate the aggregate risk exposure for the geographical area as described above with reference to FIG. 4, except that the aggregate risk exposure may be calculated by combining one or more attributes values for each insurance policy associated with the geographical area as well as one or more attribute values for the insurance policy request. This aggregate risk exposure thus represents what the risk exposure at the geographic area would be if the insurance policy request were accepted.

The risk evaluation module 206 compares this aggregate risk exposure with the maximum tolerable risk exposure for the geographical area or the baseline maximum tolerable risk exposure, as described above with reference to FIG. 5 (block 860). The results of this comparison are used to determine whether to accept or reject the insurance policy request (block 870). In response to the evaluation, the risk advisory module 208 may reject the insurance policy request if the aggregate risk exposure is greater than or equal to the maximum tolerable risk exposure, and may accept the insurance policy request if the aggregate risk exposure is less than the maximum tolerable risk exposure. In this example approach, a block may not be issued by the risk advisory module 208 in response to the evaluation. The acceptance or rejection of the insurance policy request is instead communicated to the agent or user at the computing device 202.

While the disclosure has been described with respect to specific examples including presently illustrative modes of carrying out the disclosure, a person having ordinary skill in the art, after review of the entirety disclosed herein, will appreciate that there are numerous variations and permutations of the above-described systems and techniques that fall within the spirit and scope of the disclosure.

1. (canceled)

2. A method comprising:
receiving, from a user device, an insurance policy request;
analyzing the insurance policy request to determine a geographical area associated with the insurance policy request;
determining whether the geographical area has a block issued;
upon determining there is no block issued for the geographical area, calculating an aggregate risk for the geographical area;
determining a response to the insurance policy request by evaluating the aggregate risk for the geographical area; and
displaying, by a display, the response.

3. The method of claim 2, wherein evaluating the aggregate risk for the geographical area further comprises:
retrieving a plurality of insurance policies associated with the geographical area;
retrieving a plurality of policy attributes associated with each of the plurality of insurance policies; and
calculating the aggregate risk using the plurality of policy attributes for the geographical area.

4. The method of claim 2, wherein the response is one of no block, a limited block or a complete block.

5. The method of claim 2, wherein the method further comprises:
displaying a map of the geographical area including the response.

6. The method of claim 2, wherein determining the response to the insurance policy request comprises comparing the aggregate risk of the geographical area against a maximum tolerable risk exposure.

7. The method of claim 6, wherein the maximum tolerable risk exposure is a monetary value.

8. The method of claim 6, further comprising:
calculating a discrepancy between the aggregate risk and the maximum tolerable risk exposure.

9. A system comprising:
an agent interface module that receives, from a user device, an insurance policy request, the insurance policy request being associated with a geographical area;
an aggregate risk management system communicatively coupled to the agent interface module analyzing the insurance policy request to determine if the geographical area has a block issued and upon determining there is no block issued for the geographical area, calculating an aggregate risk for the geographical area; and
a risk evaluation module communicatively coupled to the agent interface module and the aggregate risk management system evaluating the aggregate risk for the geographical area to determine a response to the insurance policy request,
wherein the agent interface module further causes the user device to display the response.

10. The system of claim 9, wherein evaluating the aggregate risk for the geographical area further comprises:
retrieving a plurality of insurance policies associated with the geographical area;
retrieving a plurality of policy attributes associated with each of the plurality of insurance policies; and
calculating the aggregate risk using the plurality of policy attributes for the geographical area.

11. The system of claim 9, wherein the response is one of no block, a limited block or a complete block.

12. The system of claim 9, wherein the agent interface module further causes the user device to display a map of the geographical area including the response.

13. The system of claim 9, wherein determining the response to the insurance policy request comprises comparing the aggregate risk of the geographical area against a maximum tolerable risk exposure.

14. The system of claim 13, wherein the maximum tolerable risk exposure is a monetary value.

15. The system of claim 13, further comprising:
calculating a discrepancy between the aggregate risk and the maximum tolerable risk exposure.

16. A non-transient computer-readable medium containing program instructions for causing a computer to perform a method of:
receiving, from a user device, an insurance policy request;
analyzing the insurance policy request to determine a geographical area associated with the insurance policy request;
determining whether the geographical area has a block issued;
upon determining there is no block issued for the geographical area, calculating an aggregate risk for the geographical area;
determining a response to the insurance policy request by evaluating the aggregate risk for the geographical area; and
displaying, by a display, the response.

17. The non-transient computer-readable medium of claim 16, wherein evaluating the aggregate risk for the geographical area further comprises:
retrieving a plurality of insurance policies associated with the geographical area;
retrieving a plurality of policy attributes associated with each of the plurality of insurance policies; and
calculating the aggregate risk using the plurality of policy attributes for the geographical area.

18. The non-transient computer-readable medium of claim 16, wherein the response is one of no block, a limited block or a complete block.

19. The non-transient computer-readable medium of claim 16, wherein the program instructions further cause the computer to perform the method of:
displaying a map of the geographical area including the response.

20. The non-transient computer-readable medium of claim 16, wherein determining the response to the insurance policy request comprises comparing the aggregate risk of the geographical area against a maximum tolerable risk exposure.

21. The non-transient computer-readable medium of claim 20, wherein the program instructions further cause the computer to perform the method of:
calculating a discrepancy between the aggregate risk and the maximum tolerable risk exposure.
